(19) United States
(12) Patent Application Publication
(10) Pub. No.: US 2025/0209116 A1
(43) Pub. Date: Jun. 26, 2025

(54) MUSIC AUTOMATIC SELECTION METHOD AND MUSIC AUTOMATIC SELECTION DEVICE

(71) Applicant: REALTEK SEMICONDUCTOR CORPORATION, HSINCHU (TW)

(72) Inventor: YING-YING CHAO, HSINCHU (TW)

(21) Appl. No.: 19/001,150

(22) Filed: Dec. 24, 2024

(30) Foreign Application Priority Data
Dec. 26, 2023 (TW) 112150717

(51) Int. Cl. G06F 16/635; G10H 1/00; G10K 11/16

(52) U.S. Cl. CPC G06F 16/636; G10H 1/0008; G10K 11/16

(57) ABSTRACT

A music automatic selection method includes: receiving a pre-recorded background sound and a real-time ambient sound by a processor; generating a noise reduction according to the pre-recorded background sound and the real-time ambient sound by the processor; generating a respiratory rate by the processor detecting a breathing sound in the noise reduction; and selecting a music according to the respiratory rate by the processor, wherein beats per minute (BPM) of the music corresponds to the respiratory rate.

### BACKGROUND OF THE INVENTION

### 1. Field of the Invention

The present disclosure relates to a music automatic selection method and a music automatic selection device, especially to a music automatic selection method and a music automatic selection device that can select a suitable music automatically according to a respiratory rate.

### 2. Description of Related Art

With the rise of health consciousness, exercise has become a popular way for people to stay healthy. To enhance the joy of exercise, an increasing number of users choose to exercise while listening to music. However, during exercise, users still need to select music manually through wearable devices, which is inconvenient for users and can impact the user experience.

### SUMMARY OF THE INVENTION

In some aspects, an object of the present disclosure is to, but not limited to, provides a music automatic selection method and a music automatic selection device that makes an improvement to the prior art.

An embodiment of a music automatic selection method of the present disclosure includes: receiving a pre-recorded background sound and a real-time ambient sound by a processor; generating a noise reduction according to the pre-recorded background sound and the real-time ambient sound by the processor; generating a respiratory rate by the processor detecting a breathing sound of the noise reduction; and selecting an initial music according to the respiratory rate by the processor, wherein a beats per minute (BPM) of the initial music corresponds the respiratory rate.

An embodiment of a music automatic selection device of the present disclosure includes a memory and a processor. The memory is configured to store a plurality of commands. The processor is coupled to the memory, and configured to read the plurality of commands from the memory to execute following steps: receiving a pre-recorded background sound and a real-time ambient sound; generating a noise reduction according to the pre-recorded background sound and the real-time ambient sound; generating a respiratory rate by detecting a breathing sound of the noise reduction; and selecting an initial music according to the respiratory rate, wherein a beats per minute (BPM) of the initial music corresponds the respiratory rate.

Technical features of some embodiments of the present disclosure make an improvement to the prior art. The music automatic selection device and the music automatic selection method of the present disclosure can instantly analyze a respiratory rate of a user to calculate a beats per minute (BPM) of a music which is suitable for a current rhythm of a user, and a suitable music is automatically selected to provide to a user, such that smoothness of a body movement of a user is enhanced.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a music automatic selection device, an audio receiving device, an audio data input interface, an audio data output interface, and a broadcasting device of the present disclosure.

FIG. 2 shows an embodiment of a flow diagram of a music automatic selection method of the present disclosure.

FIG. 3 shows an embodiment of a pre-recorded background music of the present disclosure.

FIG. 4 shows an embodiment of a pre-recorded background music of the present disclosure.

FIG. 5 shows an embodiment of a real-time ambient sound and a noise reduction of the present disclosure.

FIG. 6 shows an embodiment of a real-time ambient sound of the present disclosure.

FIG. 7 shows an embodiment of a noise reduction of the present disclosure.

### DETAILED DESCRIPTION OF THE PREFERRED EMBODIMENTS

For improving problems of users still needing to select music manually through wearable devices during exercise, which is inconvenient for the users and can impact the user experience, the present disclosure provides a music automatic selection device and a music automatic selection method, which will be explained in detail as below.

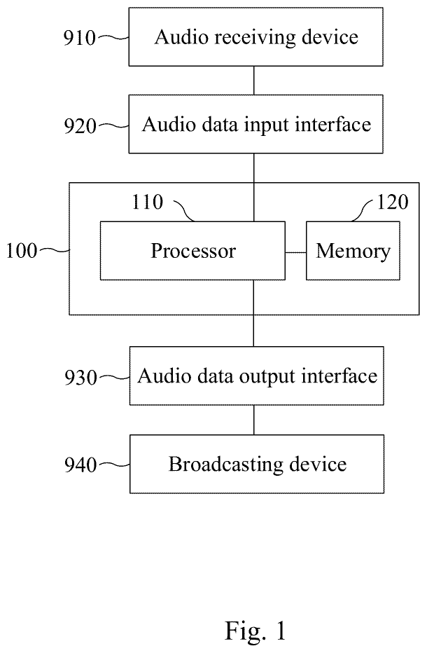

FIG. 1 shows an embodiment of a music automatic selection device 100, an audio receiving device 910, an audio data input interface 920, an audio data output interface 930, and a broadcasting device 940 of the present disclosure. As shown in the figure, the music automatic selection device 100 is coupled to the audio data input interface 920 and the audio data output interface 930, and the audio data input interface 920 and the audio data output interface 930 are coupled to the audio receiving device 910 and the broadcasting device 940 respectively.

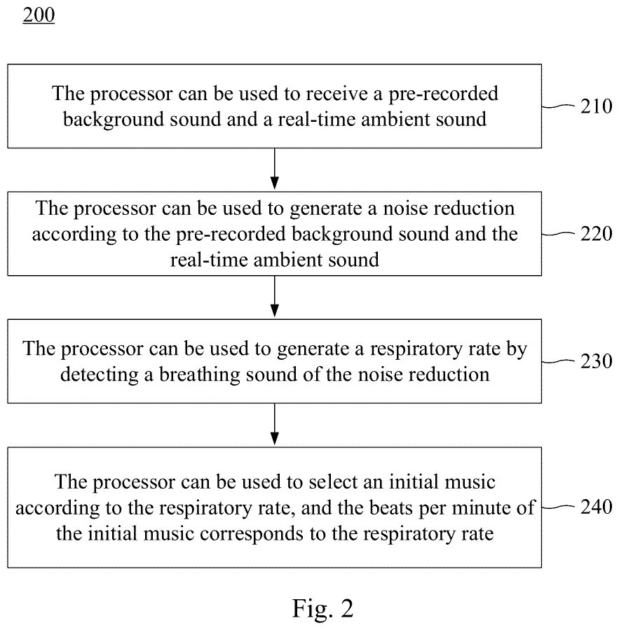

In some embodiments, the music automatic selection device 100 includes a processor 110 and a memory 120. The memory 120 is configured to store a plurality of commands. The processor 110 is configured to read the plurality of commands from the memory 120 to execute the music automatic selection method 200 as shown in FIG. 2.

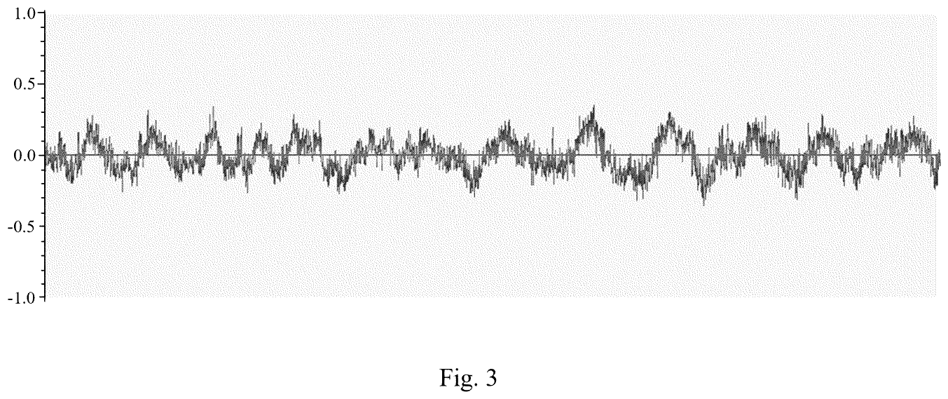

Before the music automatic selection method 200 is executed, the processor 110 can be used to control the audio receiving device 910 according to a command to record a segment of sound to be a pre-recorded background sound. Referring to FIG. 3, before exercise, users can record a sound as shown in FIG. 3 to be the pre-recorded background sound. Essentially, before exercise, a volume of a breathing sound of a user is very low. Therefore, the pre-recorded background sound generally includes ambient sounds from surroundings of the user, for example, the sounds of riverside parks, sports field, and so on. For example, a sample rate of the sound in FIG. 3 is 24000 Hz, with 1024 samples per frame.

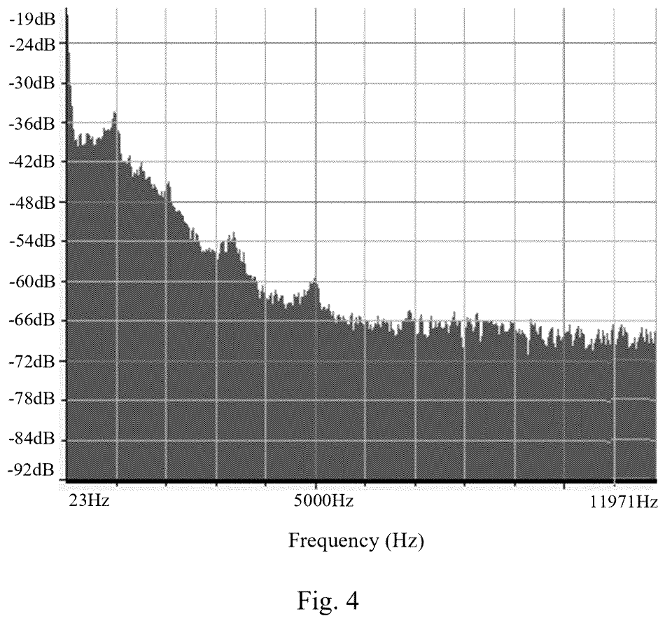

Subsequently, the processor 110 can transform the time-domain sound in FIG. 3 into the frequency-domain sound in FIG. 4. For example, the processor 110 can adopt Modulated Discrete Cosine Transform (MDCT) for converting between time and frequency domains. Assuming there are K background noise frames, a formula of the time-averaged noise spectrum is as follows:

$$\overline{{\vert N ( f ) \vert}^{b}} = \frac{1}{K} {\sum }_{i = 0}^{K - 1} {\vert {N}_{i} ( f ) \vert}^{b} \qquad formula 1$$

In formula 1, |̅N̅(̅f̅)̅|̅^̅{̅b̅}̅ is the time-averaged noise spectrum. When b is 1, it is a magnitude spectrum. When b is 2, it is a power spectrum.

The pre-recorded background sound is mainly used to be compared with the real-time ambient sound when users exercise. Subsequently, the pre-recorded background sound can be provided to the processor 110 through the audio data input interface 920.

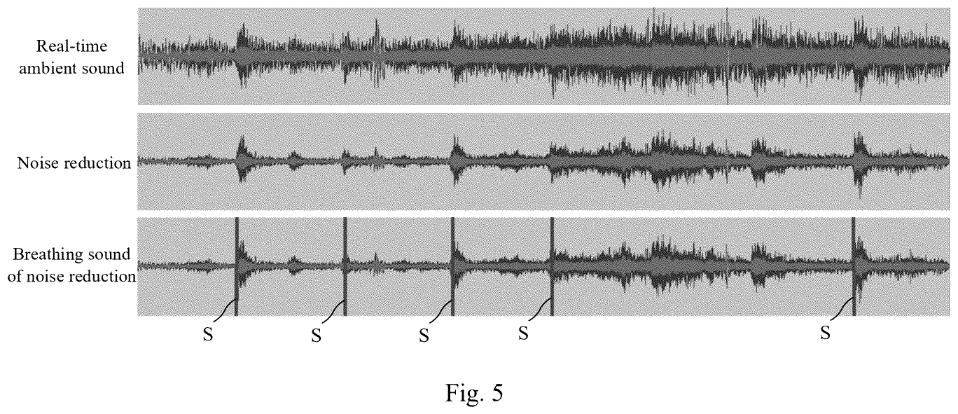

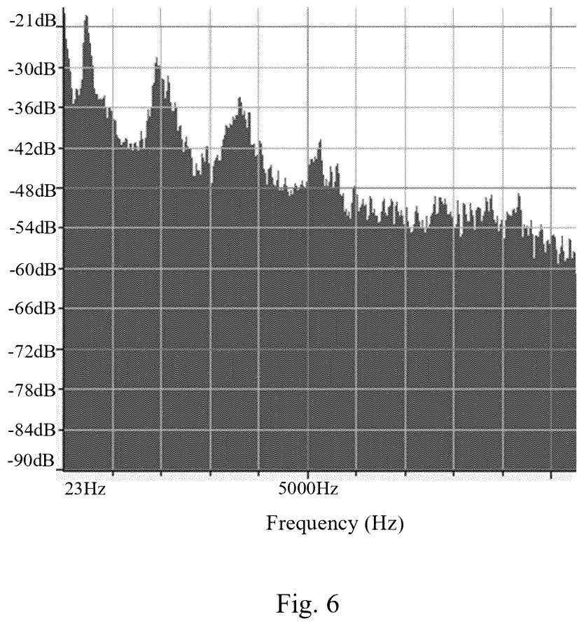

Subsequently, when the music automatic selection method 200 is executed, the processor 110 can control the audio receiving device 910 according to a command to record a sound during exercise to be a real-time ambient sound. For example, during exercise, users can record the sound of their activity to be the real-time ambient sound, and the real-time ambient sound generally includes a background sound and a breathing sound of the users during exercise. Referring to FIG. 5, during exercise, users can record the sound illustrated in FIG. 5 to be the real-time ambient sound. Subsequently, the processor 110 can transform the time-domain sound in FIG. 5 into the frequency-domain sound in FIG. 6. Similarly, the real-time ambient sound can be provided to the processor 110 through the audio data input interface 920.

Reference is now made to both FIG. 1 and FIG. 2. In step 210, the processor 110 can be used to receive a pre-recorded background sound and a real-time ambient sound. For example, when users exercise, the processor 110 can control the audio receiving device 910 according to a command to record a real-time ambient sound during exercise, and the real-time ambient sound and the pre-recorded background sound are both provided to the processor 110 through the audio data input interface 920, such that the processor 110 can execute subsequent steps.

In step 220, the processor 110 can be used to generate a noise reduction according to the pre-recorded background sound and the real-time ambient sound. For example, referring to FIG. 5, the processor 110 can subtract a portion of the pre-recorded background sound from the real-time ambient sound during exercise to obtain the noise reduction, which will be explained in detail as below.

$$y ( m ) = x ( m ) + n ( m ) \qquad formula 2$$

In formula 2, under an ideal condition, y(m) is the real-time ambient sound in the time domain, x(m) is the breathing sound in the time domain, and n(m) is the pre-recorded background sound in the time domain. Subsequently, formula 3 transforming the time-domain of formula 2 into the frequency domain is as follows:

$$Y ( f ) = X ( f ) + N ( f ) \qquad formula 3$$

In formula 3, Y(f) is the real-time ambient sound in the frequency domain, X(f) is the breathing sound in the frequency domain, and N(f) is the pre-recorded background sound in the frequency domain. In theory, the real-time ambient sound should be equal to the sum of the breathing sound and the background sound.

After organizing formula 2 and formula 3, a calculation formula for estimating the breathing sound is as follows:

$$\vert \hat{X} ( f ) {\vert}^{b} = {\vert Y ( f ) \vert}^{b} - \overline{{\vert N ( f ) \vert}^{b}} \qquad formula 4$$

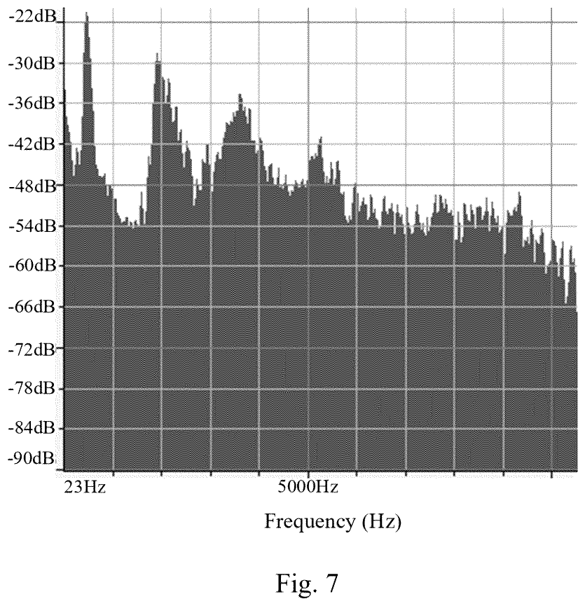

In formula 4, |\hat{X}(f)|^{b} is the estimated breathing sound, |Y(f)|^{b} is the real-time ambient sound, and |N(f)|^{b} is the pre-recorded background sound. It is noted that, in general, it is not advisable to directly subtract the pre-recorded background sound |N(f)|^{b} from the real-time ambient sound |Y(f)|^{b} to obtain the estimated breathing sound |\hat{X}(f)|^{b}, because the above-mentioned process could lead to distortion. The above-mentioned estimated breathing sound |\hat{X}(f)|^{b} can be referenced in FIG. 7.

To obtain the breathing sound, the present disclosure sets the sensitivity S (dB) and the reduction gain G (dB) according to formula 4, and the following determining formula is set:

$$If ( {\vert Y ( f ) \vert}^{b} - S > \overline{{\vert N ( f ) \vert}^{b}} ) \qquad formula 5$$

$$not noise , keep original bin value ,$$

$${\vert \hat{X} ( f ) \vert}^{b} = {\vert Y ( f ) \vert}^{b} \qquad formula 6$$

$$else$$

$$noise , reduce G for this bin ,$$

$${\vert \hat{X} ( f ) \vert}^{b} = {\vert Y ( f ) \vert}^{b} - G \qquad formula 7$$

In formulas 5˜7, if the sensitivity S is smaller, |Y(f)|^{b} is more likely to be considered as the breathing sound. Conversely, if the sensitivity S is larger, |Y(f)|^{b} is more likely to be considered as the background sound.

In formula 7, assuming that the background sound is deemed to exist in this frequency range, the recorded real-time ambient sound |Y(f)|^{b} is subtracted by the reduction gain G. At the same time, |\hat{X}(f)|^{b} is the noise reduction, the noise reduction is obtained by the processor 110 subtracting the reduction gain G from the real-time ambient sound |Y(f)|^{b} during exercise, and the reduction gain G is proportionate to the pre-recorded background sound. Subsequently, the breathing sound can be obtained from the noise reduction, which will be explained as below.

In step 230, the processor 110 can be used to generate a respiratory rate by detecting a breathing sound of the noise reduction. For example, for obtaining a respiratory rate of a user, the processor 110 can detect a breathing sound of a user from the noise reduction, and the respiratory rate can be calculated from the breathing sound. Referring to FIG. 5, there are several larger amplitude components within the noise reduction, and the larger amplitude components correspond to the exhalation sound S of the breathing sound of the user. As can be seen from the above, the breathing sound of the user can be obtained through the above-mentioned processing with further precision. The detailed calculation manner for the breathing sound is explained as follows.

$$E ( t ) = {\sum }_{i = 0}^{\frac{fs}{2} - 1} {\vert \hat{X} ( {f}_{i} ) \vert}^{b} \qquad formula 8$$

$$AvgPreE ( t ) = \frac{1}{K} {\sum }_{i = 1}^{K} \vert E ( t - i ) \vert \qquad formula 9$$

In formula 8, E(t) is the current frame energy, fs is the sampling frequency, and |\hat{X}(fᵢ)|^{b} is the noise reduction. In Formula 9, AvgPreE(t) is the average of previous frame energy. Assuming given a value of M, if the current frame energy E(t) is greater than the average of previous frame energy AvgPreE(t)×M, it represents that the breathing sound is detected at time t.

As stated above, assuming breathing sounds are detected at time points t1, t2, and t3 sequentially, the respiratory interval P1 between the time points t1 and t2 is 44 frames, and the respiratory interval P2 between the time points t2 and t3 is 45 frames. It can be observed that the difference between the respiratory intervals P1 and P2 is only 1 frame, which is very small, representing that the breathing of the user is essentially stable. It is noted that a default gap can be set in the present disclosure. If the difference between the respiratory intervals is lower than the default gap, it represents that the breathing of the user is stable. For example, the default gap in the present disclosure can be set to 2 frames. In the above-mentioned embodiment, since the difference between the respiratory intervals P1 and P2 is only 1 frame, which is lower than the default gap of 2 frames of the present disclosure, it represents that the breathing of the user is stable.

As mentioned above, since the breathing of the user is stable, the time of the single breath of the user can be calculated now, and the formula is as follows:

$$Tb = \frac{P 1 + P 2}{2} \times \frac{fsize}{fs} \qquad formula 10$$

As shown in formula 10, Tb is the time of the single breath, P1 and P2 are the respiratory intervals, f size is the frame size, and fs is the sampling frequency. Assuming the respiratory interval P1 is 44 frames, the respiratory interval P2 is 45 frames, fsize is 1024, and fs is 24000 Hz, the time of the single breath Tb is about 1.9 seconds. Respiratory rate represents the number of breaths per minute. Therefore, if we want to calculate the respiratory rate, we can divide 60 seconds by the time required for each breath. In this case, the respiratory rate is about 31.6 breaths per minute.

In step 240, the processor 110 can be used to select an initial music according to the respiratory rate, and the beats per minute of the initial music corresponds to the respiratory rate. For example, the processor 110 can instantly analyze a respiratory rate of a user to calculate a beats per minute (BPM) of a music which is suitable for a current rhythm of a user, and a suitable music is automatically selected to provide to a user, such that smoothness of a body movement of a user is enhanced.

Generally, adults typically breathe about 12 to 20 times per minute in a calm state. Therefore, the respiratory rate for adults is between 12 and 20 breaths per minute. During exercise, the respiratory rate of adults increases, the respiratory rate reaches different rates depending on the intensity of the exercise. On average, the respiratory rate for adults during exercise is around 30 breaths per minute. As mentioned in the foregoing embodiments, the respiratory rate is 31.6 breaths per minute, which represents that a cycle of inhalation and exhalation of a user is about 31.6 times per minute. If we calculate total inhalation and exhalation cycles, the sum of the total inhalation and exhalation cycles would be around 63 cycles per minute for a user. Accordingly, the music automatic selection device 100 and the music automatic selection method 200 of the present disclosure can automatically select an initial music with 63 beats per minute (BPM) and provide the initial music to a user. Since a tempo of the initial music is equal to the sum of the inhalation and exhalation cycles of a user, the initial music is highly suitable for a current rhythm of a user, such that smoothness of a body movement of a user is enhanced.

In some embodiments, the beats per minute of the initial music selected by the music automatic selection device 100 and the music automatic selection method 200 of the present disclosure is about two times of the respiratory rate. For example, if the respiratory rate of the user is calculated to be 30 beats per minute, the beats per minute of the selected initial music is 60. Similarly, if the respiratory rate of the user is calculated to be 35 beats per minute, the beats per minute of the selected initial music is 70. If the respiratory rate of the user is calculated to be 40 beats per minute, the beats per minute of the selected initial music is 80, and so on.

In some embodiments, the beats per minute of the initial music selected by the music automatic selection device 100 and the music automatic selection method 200 of the present disclosure ranges between two times of the respiratory rate and four times of the respiratory rate. For example, if the respiratory rate of the user is calculated to be 30 breaths per minute, not only can the present disclosure select the initial music with the beats per minute of 60 equaling the inhalation and exhalation cycles of the user for exercise, but it can also cater to different user preferences. For example, if the user prefers a faster rhythm, the present disclosure can select the initial music with the beats per minute of 120 for providing the user to exercise. Similarly, if the respiratory rate of the user is calculated to be 35 breaths per minute, the present disclosure can select the initial music with the beats per minute of 140. If the respiratory rate is calculated to be 40 breaths per minute, the present disclosure can select the initial music with the beats per minute of 160, and so forth.

In one embodiment, the processor 110 can adjust an initial music to a target music based on an adjusting signal. The beats per minute of the target music is equal to the beats per minute of the initial music plus a predetermined number of beats. For example, the processor 110 can obtain the commands from the memory 120 to execute an application (APP). When a user desires to increase the exercise intensity, the user can input a speed-up signal through the mentioned application (APP). The processor 110 can then adjust the beats per minute to select the target music with a BPM 5 beats higher than the initial music. For example, if the initial music has a BPM of 60, the processor 110 may select the target music with a BPM of 65 to enable the user to exercise at a faster intensity. However, the present disclosure is not limited to the above-mentioned embodiments, and it is provided for illustrative purposes to demonstrate one implementation of the present disclosure, making the technical features of the present disclosure easier to understand. In other embodiments, the processor 110 may select the target music with BPM higher by 10, 15, 20 beats, and so on, depending on the actual requirements.

In one embodiment, the processor 110 can adjust the initial music to the target music based on an adjusting signal. The beats per minute of the target music is equal to the beats per minute of the initial music minus a predetermined number of beats. For example, the processor 110 can obtain the commands from the memory 120 to execute an application (APP). When a user desires to decrease the exercise intensity, the user can input a speed reduction signal through the mentioned application (APP). The processor 110 can then adjust the beats per minute to select the target music with a BPM 5 beats lower than the initial music. For example, if the initial music has a BPM of 60, the processor 110 may select the target music with a BPM of 55 to enable the user to exercise at a slower intensity. However, the present disclosure is not limited to the above-mentioned embodiments, and it is provided for illustrative purposes to demonstrate one implementation of the present disclosure, making the technical features of the present disclosure easier to understand. In other embodiments, the processor 110 may select the target music with BPM lower by 10, 15, 20 beats, and so on, depending on the actual requirements.

In one embodiment, the music automatic selection device 100 and the music automatic selection method 200 of the present disclosure can be applied to various consumer electronics such as smartphones, tablets, wearable devices, and so on. In addition, it is noted that the present disclosure is not limited to the embodiments as shown in FIG. 1 to FIG. 7, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The music automatic selection device and the music automatic selection method of the present disclosure can instantly analyze a respiratory rate of a user to calculate a beats per minute of a music which is suitable for a current rhythm of a user, and a suitable music is automatically selected to provide to a user, such that smoothness of a body movement of a user is enhanced.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A music automatic selection method, comprising:
receiving a pre-recorded background sound and a real-time ambient sound by a processor;
generating a noise reduction according to the pre-recorded background sound and the real-time ambient sound by the processor;
generating a respiratory rate by the processor detecting a breathing sound of the noise reduction; and
selecting an initial music according to the respiratory rate by the processor, wherein a beats per minute (BPM) of the initial music corresponds the respiratory rate.

2. The music automatic selection method of claim 1, wherein the beats per minute of the initial music is about two times of the respiratory rate.

3. The music automatic selection method of claim 1, wherein the beats per minute of the initial music ranges between two times of the respiratory rate and four times of the respiratory rate.

4. The music automatic selection method of claim 1, further comprising:
adjusting the initial music to be a target music according to an adjusting signal by the processor, wherein the beats per minute of the target music is equal to the beats per minute of the initial music plus a predetermined number of beats.

5. The music automatic selection method of claim 1, further comprising:
adjusting the initial music to be a target music according to an adjusting signal by the processor, wherein the beats per minute of the target music is equal to the beats per minute of the initial music minus a predetermined number of beats.

6. A music automatic selection device, comprising:
a memory, configured to store a plurality of commands;
a processor, coupled to the memory, and configured to read the plurality of commands from the memory to execute following steps:
receiving a pre-recorded background sound and a real-time ambient sound;
generating a noise reduction according to the pre-recorded background sound and the real-time ambient sound;
generating a respiratory rate by detecting a breathing sound of the noise reduction; and
selecting an initial music according to the respiratory rate, wherein a beats per minute of the initial music corresponds the respiratory rate.

7. The music automatic selection device of claim 6, wherein the beats per minute of the initial music is about two times of the respiratory rate.

8. The music automatic selection device of claim 6, wherein the beats per minute of the initial music ranges between two times of the respiratory rate and four times of the respiratory rate.

9. The music automatic selection device of claim 6, wherein the processor is further configured to read the plurality of commands from the memory to execute following steps:
adjusting the initial music to be a target music according to an adjusting signal, wherein the beats per minute of the target music is equal to the beats per minute of the initial music plus a predetermined number of beats.

10. The music automatic selection device of claim 6, wherein the processor is further configured to read the plurality of commands from the memory to execute following steps:
adjusting the initial music to be a target music according to an adjusting signal, wherein the beats per minute of the target music is equal to the beats per minute of the initial music minus a predetermined number of beats.
